(19) United States
(12) Patent Application Publication
(10) Pub. No.: US 2010/0247744 A1
(43) Pub. Date: Sep. 30, 2010

(54) METHOD FOR PAINTING AUTOMOBILE BODY AND SYSTEM THEREFOR

(75) Inventors: Kazuhi KOGA, Hiroshima-shi (JP); Hiroshi KUBOTA, Aki-gun (JP); Takakazu YAMANE, Hiroshima-shi (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/719,473

(22) Filed: Mar. 8, 2010

(30) Foreign Application Priority Data
Mar. 30, 2009 (JP) 2009-082020

(51) Int. Cl. B05D 1/36; B05C 11/00; B05C 5/02

(52) U.S. Cl. 427/8; 427/402; 118/712; 118/300

(57) ABSTRACT

A method for painting an automobile body, which comprises: a first paint film-forming step K1 of applying a first paint to an outer plate surface 2 of the automobile body having a basecoat film 4 formed thereon, to form thereon a first paint film 5 having a basecoat hiding ability; a second paint film-forming step K2 of, after the formation of the first paint film 5, applying a second paint to the first paint film 5 to form thereon a second paint film 6 which has a basecoat hiding ability lower than that of the first paint film 5 and exhibits an apparent paint-film color only by itself or in cooperation with the first paint film 5; and a third paint film-forming step K3 of, at least after the first paint film-forming step K1, applying a third paint to an inner panel surface 3 of the automobile body having a basecoat film 4 formed thereon, to form thereon a third paint film 7 exhibiting an apparent paint-film color identical or similar to that of the second paint film 6 of the outer panel surface 2, and a system for performing the method.

### BACKGROUND OF THE INVENTION

1. Field of the Invention

The present invention relates to a method for painting an automobile body and a system therefor, and, more specifically, to a method for applying paint to an outer panel surface and an inner panel surface of an automobile body each having a basecoat film formed thereon, to perform a painting operation, and a system therefor.

2. Description of the Related Art

Heretofore, with a view to improving chipping resistance and smoothness of a multilayer topcoat film which is formed on an electrodeposition painted surface by sequentially applying a first pigmented topcoat paint, a second pigmented topcoat paint and a clear paint to the surface, there has been known a painting method for an article made of an electrically conductive metal, such as an outer panel member of an automobile, which is designed to sequentially apply a first pigmented topcoat paint, a second pigmented topcoat paint and a clear paint to a cathodic electrodeposition painted surface to form a multilayer topcoat film on the surface, wherein the first pigmented topcoat paint is a pigmented paint which uses, as a resin component, (1) a mixture of a hydroxyl group-containing resin and a melamine resin or (2) a mixture of a carboxyl group-containing resin and an epoxy group-containing resin, and contains a flaky pigment in an amount of 0.5 weight parts or more per 100 weight parts of solid content of the resin component, as disclosed in JP 2000-281962A (Patent Document 1).

As above, in a multilayer paint film-forming method which comprises sequentially applying a first paint (first pigmented topcoat paint), a second paint (second pigmented topcoat paint) and a clear paint to a cathodic electrodeposition painted surface, and then simultaneously hardening the three paints to form a multilayer topcoat film, a flaky pigment is incorporated into the first paint in a specific amount, which makes it possible to improve chipping resistance and smoothness of the topcoat film, even if the step of applying or drying a midcoat paint in a conventional method is omitted.

However, if the application of a midcoat paint is omitted as mentioned above, functions of the midcoat paint, such as an ultraviolet-blocking function, cannot be obtained. Thus, in cases where each of the above topcoat paints is a paint poor in the ultraviolet-blocking function, such as a blue, white or red paint, it is unable to prevent ultraviolet rays from reaching a basecoat film formed on an outer panel surface of an automobile body by an electrodeposition paint, which causes a problem that the basecoat film is liable to prematurely deteriorate under influence of the ultraviolet rays.

As measures to prevent the above adverse effect, it is contemplated to incorporate a pigment having a function of reflecting or absorbing ultraviolet rays, into the first paint, to hide and protect the basecoat film. However, in this case, the pigment incorporated in the first paint is likely to adversely affect a paint applied on an inner panel surface of the automobile body.

Specifically, the second paint to be applied to the outer panel surface of the automobile body is designed to exhibit an apparent color of a paint film (apparent paint-film color) in the automobile body, wherein the color is selected from a large number of types of predetermined colors. Further, from a standpoint of aesthetic appearance, a third paint film formed of a third paint to be applied to the inner panel surface is generally set to have a color identical or similar to that of a second paint film formed of the second paint to be applied to the outer panel surface.

In contrast, the first paint to be applied underneath the second paint film formed of the second paint may be set to have an achromatic color, as long as it allows the upper paint film to exhibit a desired apparent paint-film color. This makes it possible to allow the first paint to have versatility. However, in this case, if a dust of the first paint attaches onto the third paint film of the inner panel surface during an operation of applying the first paint to the outer panel surface of the automobile body, it causes a problem of deterioration in aesthetic appearance of the paint film of the inner panel surface.

In cases where the paint film formed of the first paint is set to have a color identical or similar to those of the paint film formed of the second paint exhibiting an apparent paint-film color and the paint film formed of the third paint to be applied to the inner panel surface, even if a dust of the first paint attaches onto the third paint film of the inner panel surface, aesthetic appearance of the paint film of the inner panel surface will not significantly deteriorate. However, as a prerequisite to allowing the paint film formed of the first paint with the pigment having an ability to hide the basecoat film (hereinafter referred to as “basecoat hiding ability”), to be set to have a color corresponding to a respective one of various types of apparent paint-film colors, it is necessary to prepare a large number of pipes required for application of respective ones of the first paints, and frequently change between the pipes, which inevitably causes deterioration in efficiency of a painting operation.

In view of the above problems, it is an object of the present invention to provide an automobile body painting method capable of effectively preventing deterioration in aesthetic appearance due to a phenomenon that a dust of a first paint applied on an outer panel surface of the automobile body attaches onto a third paint film of an inner panel surface of the automobile body, in a simple operation, and a system therefor.

### SUMMARY OF THE INVENTION

In order to achieve the above object, according to one aspect of the present invention, there is provides a method for painting an automobile body, which includes a first paint film-forming step of applying a first paint to an outer plate surface of the automobile body having a basecoat film formed thereon, to form thereon a first paint film having a basecoat hiding ability, and a second paint film-forming step of, after the formation of the first paint film, applying a second paint to the first paint film to form thereon a second paint film which has a basecoat hiding ability lower than that of the first paint film and exhibits an apparent paint-film color only by itself or in cooperation with the first paint film. The method is characterized by comprising a third paint film-forming step of, at least after the first paint film-forming step, applying a third paint to an inner panel surface of the automobile body having a basecoat film formed thereon, to form thereon a third paint film exhibiting an apparent paint-film color identical or similar to that of the second paint film of the outer panel surface.

In the present invention, at least after the formation of the first paint film, the third paint to the inner panel surface is applied the inner panel surface to form thereon the third paint film exhibiting an apparent paint-film color identical or similar to that of the second paint film of the outer panel surface, so that the third paint film can hide a dust paint film formed by a dust of the first paint attached on the inner panel surface during the first paint film-forming step. This makes it possible to maintain aesthetic appearance of the inner plate surface in an excellent state.

These and other objects, features and advantages of the present invention will become apparent upon reading the following detailed description along with the accompanying drawings.

### BRIEF DESCRIPTION OF THE DRAWINGS

FIG. 1 is a process diagram showing an automobile body painting method according to a first embodiment of the present invention.

FIG. 2 is an explanatory diagram showing a paint film configuration formed by a conventional painting method as a comparative example.

FIG. 3 is an explanatory diagram showing a paint film configuration formed by the painting method according to the first embodiment.

FIG. 4 is an explanatory diagram showing a light reflection state in a paint film formed by a painting method according to the present invention.

FIG. 5 is a process diagram showing an automobile body painting method according to a second embodiment of the present invention.

FIG. 6 is an explanatory diagram showing a paint film configuration formed by the painting method according to the second embodiment.

### DETAILED DESCRIPTION OF THE INVENTION

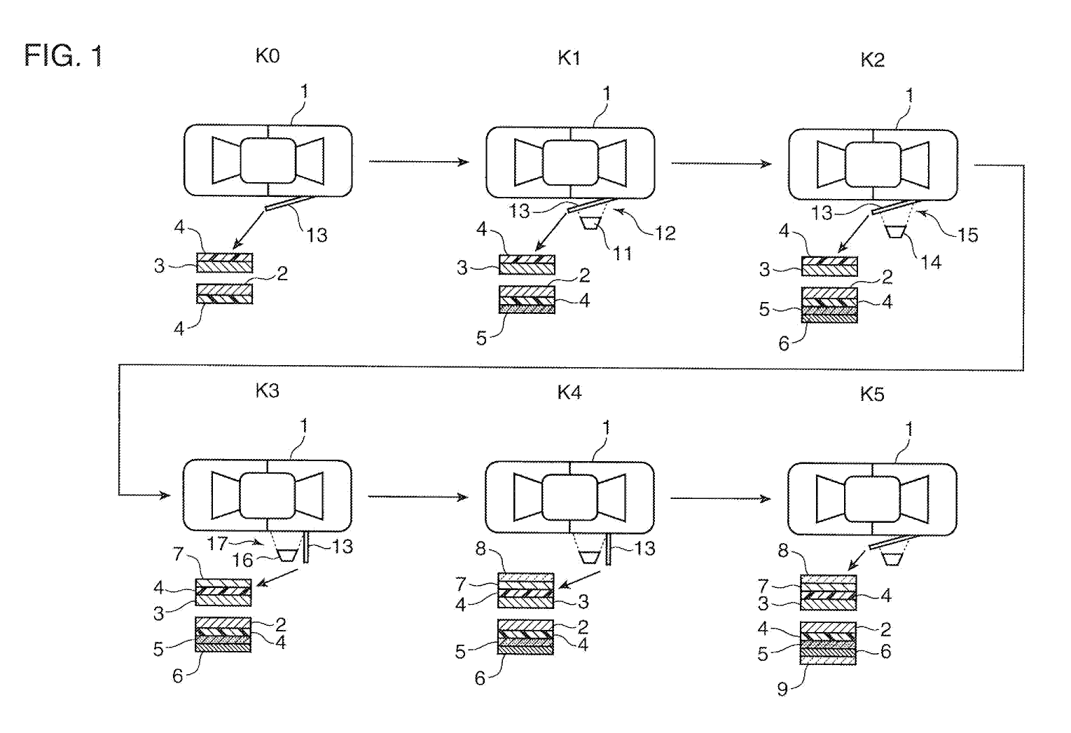

FIG. 1 is a process diagram showing an automobile body painting method using an automobile body painting system, according to a first embodiment of the present invention. The painting method according to the first embodiment comprises: a basecoat film-forming step K0 of forming a basecoat film 4 on each of an outer panel surface 2 and an inner panel surface 3 of an automobile body 1; a first paint film-forming step K1 of forming a first paint film 5 on the basecoat film 4 of the outer panel surface 2; a second paint film-forming step K2 of forming a second paint film 6 on the first paint film 5 of the outer panel surface 2; a third paint film-forming step K3 of forming a third paint film 7 on the basecoat film 4 of the inner panel surface 3; an inner-panel clear paint film-forming step K4 of forming a clear paint film 8 on the third paint film 7 of the inner panel surface 3; an outer-panel clear paint film-forming step K5 of forming a clear paint film 9 on the second paint film 6 of the outer panel surface 2; and a baking/drying step (not shown) of baking and drying the first to third paint films 5 to 7 and the clear paint films 8, 9.

In the basecoat film-forming step K0, a basecoat film 4 having a function of protecting the automobile body 1 from rust (corrosion), etc, is formed on each of the outer and inner panel surfaces 2, 3 of the automobile body 1, for example, by: applying a DC current between the automobile body 1 and an electrodeposition paint contained in a tank, while immersing the automobile body 1 in the tank, to subject the automobile body 1 to an electrodeposition painting process to form an electrodeposition paint film thereon; pulling the automobile body 1 up out of the tank; and transporting the automobile body 1 to a drying furnace to bake and dry the electrodeposition paint film. The electrodeposition painting process includes an anionic type using chromate or the like as an anti-rust (anti-corrosive) material, and a cathodic type using an amine-modified resin obtained by modifying a resin excellent in anti-rust (anti-corrosive) ability, such as an epoxy resin, with amine.

In the first paint film-forming step K1, a first paint film 5 having a high basecoat hiding ability is formed on the basecoat film 4 of the outer panel surface 2 of the automobile body 1, in a first paint-film forming station 12 having an electrostatic painting machine 11, such as an air-spray, airless-spray or electrostatic atomization-type painting machine, by spray-applying a first paint to the outer panel surface 2, under a condition that an openable/closable member 13, such as an automobile side door, is approximately closed. The first paint is a liquid paint adapted to form the first paint film 5 having a basecoat hiding ability, wherein the liquid paint is obtained by dissolving or dispersing a pigment for allowing the first paint film 5 to exhibit a given color, a resin component and others, in a solvent consisting of an organic solvent or a water solvent. According to need, the first paint may further contain an extender pigment, an antisettling agent, a paint surface regulator, an ultraviolet absorber, an ultraviolet stabilizer and a tackifier, in an appropriate manner.

For example, the pigment to be contained in the first paint may be one selected from the group consisting of carbon black, titanium oxide, iron oxide, aluminum flake, and a combination of two or more thereof. According to need, the pigment may contain a given color pigment, such as one selected from the group consisting of zinc flower (zinc oxide), cadmium red, molybdenum red, chromium yellow, chromium oxide, Prussian blue, cobalt blue, azo-series pigment, phthalocyanine-series pigment, quinacridone-series pigment, isoindoline-series pigment, threne-series pigment and perylene-series pigment, or a mixture of two or more thereof.

Preferable, the resin component to be contained in the first paint is a thermosetting resin composition. The thermosetting resin composition may include: a composition comprising a matrix resin, such as an acrylic resin, a polyester resin or an alkyd resin, which has a cross-linkable functional group, and a cross-linking agent, such as a melamine resin, an urea resin or a polyisocyanate compound (including a block copolymer thereof); and an acid/epoxy cross-linked resin composition comprising a primary component of an acid group-containing resin and an epoxy group-containing resin. More preferably, the resin component to be contained in the first paint is a thermosetting resin composition comprising: a matrix resin, such as an acrylic resin, a polyester resin or an alkyd resin, which has a cross-linkable functional group, such as a hydroxyl group, a carboxyl group or an epoxy group; and a cross-linking agent, such as a melamine resin.

For example, in case where a gray pigment, such as carbon black or titanium oxide, is used as the pigment to be contained in the first paint, a color of the first paint film 5 is set to an achromatic color having a brightness corresponding to that of the second paint film 6 to be formed on the first paint film 5. Specifically, the color of the first paint film 5 may be set to one selected from five achromatic colors having five levels of brightnesses consisting of dark gray, gray, light gray, super-light gray and white, wherein the selected achromatic color has an excellent basecoat hiding ability. Further, in cases where an amount of the color pigment to be contained in the first paint is set at a value greater than a normal value, i.e., the amount of the color pigment is set to allow the brightness of the first paint film 5 to become less than a brightness corresponding to that of the second paint film 6, the basecoat hiding ability of the first paint film 5 can be sufficiently ensured.

Subsequently, in the second paint film-forming step K2, a second paint film 6 is formed on the first paint film 5 of the outer panel surface 2, in a second paint film-forming station 15 having an electrostatic painting machine 14, such as an air-spray, airless-spray or electrostatic atomization-type painting machine, by spray-applying a second paint to the first paint film 5 of the outer panel surface 2, while keeping the first paint film 5 from being hardened, i.e., maintaining the first paint film 5 in its unhardened state, under a condition that the openable/closable member 13, such as the an automobile side door, is approximately closed. The second paint is a liquid paint obtained by dissolving or dispersing a color pigment for allowing the second paint film 6 to exhibit a given apparent paint-film color, a resin component and others, in a solvent consisting of an organic solvent or a water solvent. According to need, the second paint may further contain an extender pigment, an antisettling agent, a paint surface regulator, an ultraviolet absorber, an ultraviolet stabilizer and a tackifier, in an appropriate manner.

The color pigment to be contained in the second paint is a type which has a basecoat hindering ability lower than that of the first paint film 5, and allows the second paint film 6 to exhibit a specific color selected from a large number of predetermined apparent paint-film colors, only by itself or in cooperation with the first paint film 5. More specifically, the color pigment may be one selected from the group consisting of titanium oxide, zinc flower (zinc oxide), carbon black, cadmium red, molybdenum red, chromium yellow, chromium oxide, Prussian blue, cobalt blue, azo-series pigment, phthalocyanine-series pigment, quinacridone-series pigment, isoindoline-series pigment, threne-series pigment and perylene-series pigment, or a mixture of two or more thereof.

Then, in the third paint film-forming step K3, a third paint film 7 exhibiting an apparent paint-film color of the inner panel surface 3 is formed on the basecoat film 4 of the inner panel surface 3, in a third paint film-forming station 17 having an electrostatic painting machine 16, such as an air-spray, airless-spray or electrostatic atomization-type painting machine, by spray-applying a third paint to the inner panel surface 3, under a condition that the electrostatic painting machine 16 is introduced inside the automobile body 1 while largely opening the openable/closable member 13. The third paint is a liquid paint obtained by dissolving or dispersing a color pigment for allowing the third paint film 7 to exhibit a given apparent paint-film color, a resin component and others, in a solvent consisting of an organic solvent or a water solvent. According to need, the third paint may further contain an extender pigment, an antisettling agent, a paint surface regulator, an ultraviolet absorber, an ultraviolet stabilizer and a tackifier, in an appropriate manner. The same pigment as that contained in the second paint is used as the pigment to be contained in the third paint, so that the third paint film 7 formed of the third paint can exhibit an apparent paint-film color identical or similar to that of the second paint film 6 formed of the second paint.

In cases where a water-soluble paint is used as each of the first to third paints forming the first to third paint films 5 to 7, after performing a pre-heating operation for vaporizing water therein, the process is shifted to the inner-panel clear paint film-forming step K4. In the inner-panel clear paint film-forming step K4, a clear paint film 8 is formed on the third paint film 7 of the inner panel surface 3, by applying a clear paint to the third paint film 7 of the inner panel surface 3 using a spray painting technique, such as an air-spraying technique, an airless-spraying technique or an electrostatic spraying technique. For example, the clear paint may be a liquid paint containing a thermosetting resin composition and a solvent. According to need, the clear paint may further contain a photoluminescent pigment, a color pigment, an antisettling agent, a paint surface regulator, an ultraviolet absorber, an ultraviolet stabilizer and a tackifier, in an appropriate manner. Preferably, the photoluminescent pigment and the color pigment are mixed in the clear paint to an extent capable of preserving transparency of the clear paint film 8.

Then, the process is shifted to the outer-panel clear paint film-forming step K5. In the outer-panel clear paint film-forming step K5, a clear paint film 9 is formed on the second paint film 6 of the outer panel surface 2, by applying a clear paint to the second paint film 6 of the outer panel surface 2 using a spray painting technique, such as an air-spraying technique, an airless-spraying technique or an electrostatic spraying technique, in the same manner as that in the inner-panel clear paint film-forming step K4. Then, in the baking/drying step (not shown), the above paint films are simultaneously hardened by heating them at a temperature of about 140° C. for about 30 minutes.

As above, in the first embodiment, the automobile body painting method using the automobile body painting system comprises: the first paint film-forming step K1 of applying a first paint to an outer panel surface 2 of an automobile body 1 having a basecoat film 4 formed thereon, to form thereon a first paint film 5 having a basecoat hiding ability; the second paint film-forming step K2 of, after the formation of the first paint film 5, applying a second paint to the first paint film 5 to form thereon a second paint film 6 having a basecoat hiding ability lower than that of the first paint film 5 and exhibiting an apparent paint-film color only by itself or in cooperation with the first paint film 5; and the third paint film-forming step K3 of, at least after the formation of the first paint film 5, applying a third paint to an inner panel surface 3 of the automobile body 1 having a basecoat film 4 formed thereon, to form thereon a third paint film 7 exhibiting an apparent paint-film color identical or similar to that of the second paint film 6 of the outer panel surface 2. This provides an advantage of being able to allow the first paint to have versatility to facilitate reduction in facility cost and effectively simplify a painting operation, while preventing deterioration in aesthetic appearance due to a phenomenon that a dust of the first paint applied on the outer panel surface 2 of the automobile body 1 attaches onto the third paint film 7 of the inner panel surface 3.

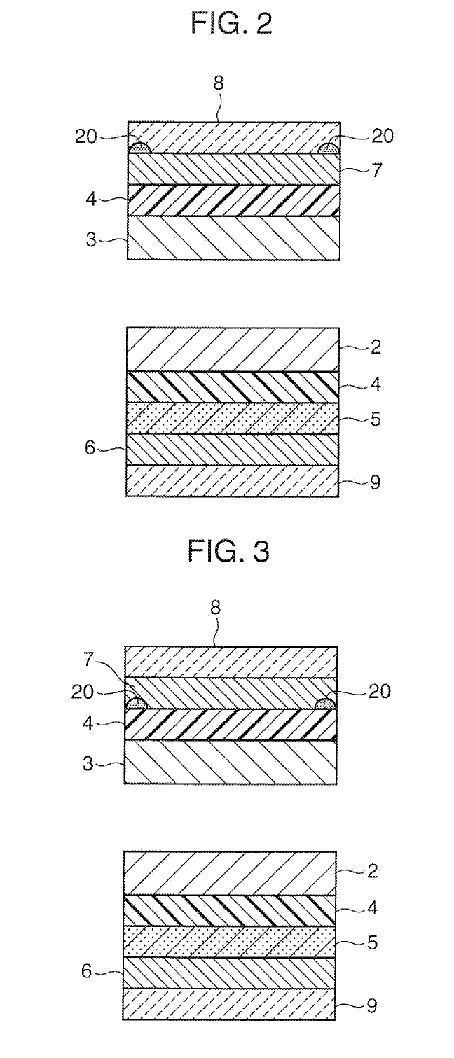

Specifically, in a conventional painting method, the first paint film-forming step of forming the first paint film 5 on the outer panel surface 2 of the automobile body 1 is performed after completion of the third paint film-forming step of forming the third paint film 7 on the inner panel surface 3 of the automobile body 1. In this process sequence, a dust of the first paint sprayed in the first paint film-forming step to form the first paint film 5 on the basecoat film 4 of the outer panel surface 2 inevitably enters the inside of the automobile body and attaches onto a peripheral edge region of the inner panel surface 3 and others, as shown in FIG. 2.

Consequently, in cases where the first paint film 5 formed of the first paint is set to have a color different from that of the third paint film 7 formed of the third paint, specifically, in one example where the first paint film 5 and the third paint film 7 are set to have an achromatic color and a chromatic color identical or similar to that of the second paint film 6, respectively, a first pant-based dust paint film 20 attached on the inner panel surface 3 exhibits a color different from that of the third paint film 7 exhibiting an apparent paint-film color of the inner panel surface 3, which inevitably causes deterioration in aesthetic appearance. Although the clear paint film 8 is formed as an upper layer relative to the dust paint film 20 and the third paint film 7, the clear paint layer 8 cannot hide the difference or change in color, because it has no basecoat hiding ability.

In contrast, in the first embodiment, the third paint film-forming step K3 using the third paint film-forming station 17 is performed after the formation of the first paint film 5, in such a manner that the third paint film 7 exhibiting an apparent paint-film color identical or similar to that of the second paint film 6 of the outer panel surface 2 is formed on the inner panel surface 3. In this process sequence, even if a dust paint film 21 is formed by a dust of the first paint attached on the inner panel surface 3 as shown in FIG. 3, the third paint film 7 can hide the dust paint film 21 to maintain aesthetic appearance of the inner plate surface 3 in an excellent state.

Further, the color of the first paint film 5 may be set to one selected from five achromatic colors having five levels of brightnesses consisting of dark gray, gray, light gray, super-light gray and white, in such a manner as to allow the second paint film 6 to exhibit the apparent paint-film color only by itself, or in cooperation with the first paint film 5. In this case, the first paint for the first paint film can have versatility. This provides an advantage of being able to reduce the number of pipes required for the application of the first paint to effectively simplify a structure of the painting system, as compared with cases where the first paint film 5 is set to have the same color as that of the second paint film 6, while effectively preventing deterioration in aesthetic appearance due to the phenomenon that a dust of the first paint applied on the outer panel surface 2 of the automobile body 1 attaches onto the third paint film 7 of the inner panel surface 3. In addition, the number of operations of changing the pipe during the formation of the first paint film 5 can be significantly reduced, as compared with the number of the pipe changing operations in cases where the operation has to be performed every time a color of each paint for forming the second and third paint films 6, 7 exhibiting an apparent paint-film color is variously changed. This provides an advantage of being able to improve efficiency of a painting operation.

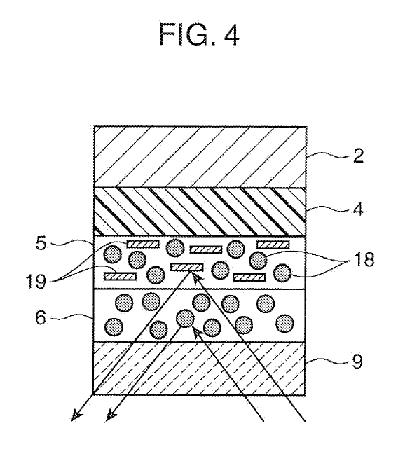

It is not necessary to allow the first paint film 5 to exhibit a color identical or similar to the apparent paint-film color. Thus, as shown in FIG. 4, the first paint for forming the first paint film 5 may incorporate a pigment having a basecoat hiding ability, such as carbon black 18, or may contain a color pigment 19 in an amount greater than a normal amount for providing a brightness corresponding to that of the second paint film. In this case, the basecoat hiding ability of the first paint film 5 can be effectively improved. This makes it possible to reflect or absorb light, such as visible light or ultraviolet light, irradiating the outer panel surface 2 by the carbon black 18 or the color pigment 19 incorporated in the first paint film 5, so as to restrain the irradiating light, such as ultraviolet light, from reaching the basecoat film 4, while simplifying the painting operation by omitting an operation of applying a midcoat paint to the basecoat film 4 formed on the outer panel surface 2 and drying the midcoat paint. This provides an advantage of being able to effectively prevent premature deterioration of the basecoat film 4 due to ultraviolet light irradiating the basecoat film 4, in a simple manner.

Particularly, in cases where the amount of the color pigment 19 to be contained in the first paint is set at a value greater than the normal value to allow a brightness of the first paint film 5 formed in the first paint film-forming step K1 to become lower than that of the second paint film 6 formed in the second paint film-forming step K2, the basecoat hiding ability of the first paint film 5 can be ensured while omitting the basecoat-hiding pigment, such as the carbon black 18, or reducing an amount of the basecoat-hiding pigment to be contained in the first paint film 5. This provides an advantage of being able to effectively suppress premature deterioration of the basecoat film 4 due to ultraviolet light irradiating the basecoat film 4, in a simpler manner.

In the first embodiment, the third paint film-forming step K3 using the third paint film-forming station 17 is performed after completion of both the first paint film-forming step K1 and the second paint film-forming step K2 using the first paint film-forming station 12 and the second paint film-forming station 15 for forming the first paint film 5 and the second film 6 on the outer panel surface 2 of the automobile body 1, as described above. In this case, the number of operations of opening/closing the openable/closable member 13, such as the an automobile side door, can be reduced, as compared with the cases where the third paint film-forming step K3 is performed between the first paint film-forming step K1 and the second paint film-forming step K2, so that the painting operation can be more simplified, as compared with an after-mentioned second embodiment of the present invention. In addition, this provides another advantage of being able to suppress the occurrence of an undesirable situation where foreign particles stirred up by an operation of opening/closing the openable/closable member 13 attach on the paint films, to effectively improve paint film quality.

Further, the method according to the first embodiment comprises the outer-panel clear paint film-forming step K5 of forming a clear paint film 9 on the second paint film 6 formed on the outer panel surface 2 of the automobile body 1. Thus, the clear paint film 9 formed in the outer-panel clear paint film-forming step K5 can protect the second paint film 6 to effectively maintain weather resistance and smoothness thereof. This makes it possible to sufficiently ensure smoothness of the outer panel surface 2 even if a dust of the third paint sprayed toward the inner panel surface 3 in the third paint film-forming step K3 attaches on the second paint film 6 of the outer panel surface 2.

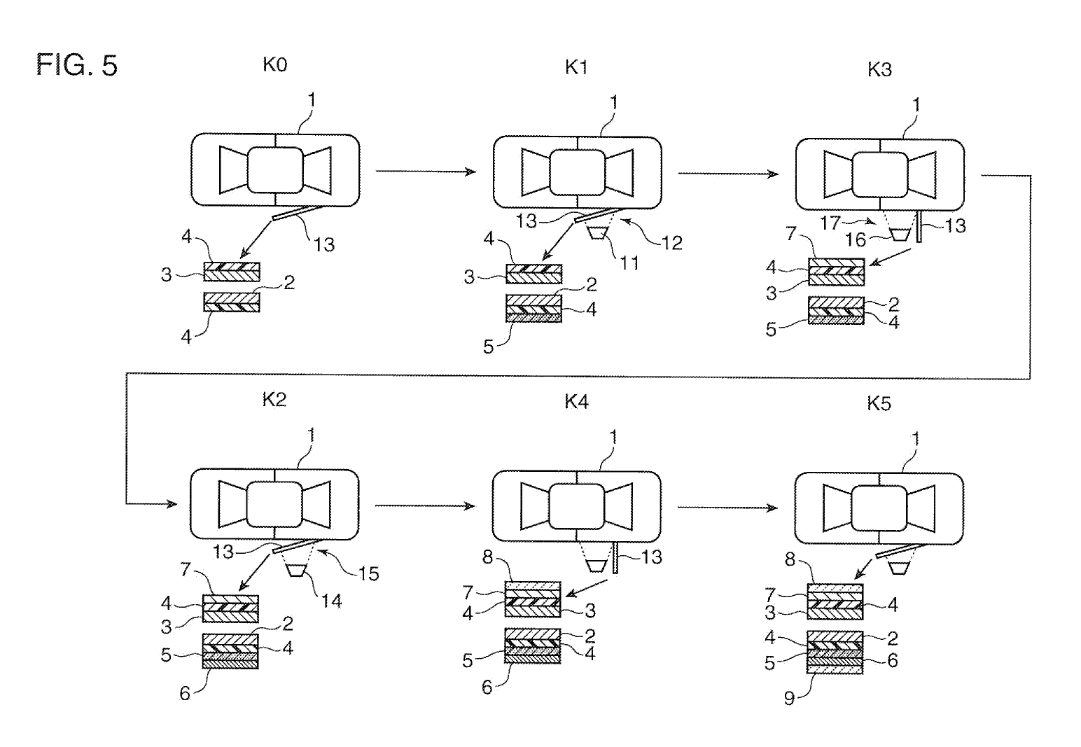

FIG. 5 is a process diagram showing an automobile body painting method using an automobile body painting system, according to a second embodiment of the present invention.

The automobile body painting method according to the second embodiment comprises a first paint film-forming step K1 of forming a first paint film 5 on a basecoat film 4 formed on an outer panel surface 2 of an automobile body 1, as with the first embodiment. In the method according to the first embodiment, the first paint film 5 and the second paint film 6 are successively formed on the outer panel surface 2 of the automobile body 1 in the first paint film-forming step K1 and the second paint film-forming step K2. The method according to the second embodiment is different from the method according to the first embodiment, in that, after forming the first paint film 5 using a first paint film-forming station 12 in the first paint film-forming step K1, the automobile body 1 is transferred to a third paint film-forming station 17 while opening an openable/closable member 13 in an approximately closed state, to perform a third paint film-forming step K3 of forming a third paint film 7 on a basecoat film 4 formed on an inner panel surface 3 of the automobile body 1, and then, after the formation of the third paint film 7, the automobile body 1 is transported to a second paint film-forming station 15 while approximately closing the openable/closable member 13 in the open state, to perform a second paint film-forming step K2 of forming a second paint film 6 on the first paint film 5 of the outer panel surface 2.

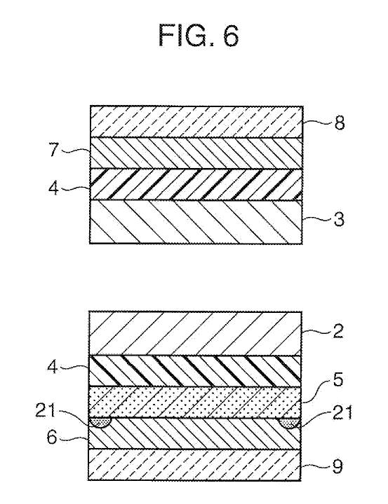

In the second embodiment, the third paint film-forming step K3 is performed between the first paint film-forming step K1 and the second paint film-forming step K2, as described above. In this case, there is no risk of the occurrence of deterioration in aesthetic appearance due to a phenomenon that a first paint for the first paint film 6 attaches on the third paint film 7. Further, even if a dust of a third paint sprayed in the third paint film-forming step K3 attaches on the first paint film 5 of the outer panel surface 2 to form a dust paint film 21 as shown in FIG. 6, the second paint film 6 is formed thereon to hide the dust paint film 21. This provides an advantage of being able to reliably prevent the occurrence of an undesirable situation where the dust of the third paint is exposed on the outer panel surface 2 to cause deterioration in aesthetic appearance in the outer panel surface 2 of the automobile body 1, even if respective colors of the first paint film 6 and the third paint film 7 are slightly different from each other.

In the second embodiment, there is a possibility that a dust of a second paint sprayed toward the outer panel surface 2 in the second paint film-forming step K2 attaches on the third paint film 7 of the inner panel surface 3. However, there is no risk of significant deterioration in aesthetic appearance of the inner panel surface 3, because the second paint is set to have a color identical or similar to that of the third paint for the third paint film 7. Further, requirements on aesthetic appearance of the inner panel surface 3, such as color uniformity and smoothness, are not so severe as compared with the outer panel surface 2. Thus, there is no risk of the occurrence of adverse effects arising from the phenomenon that the second paint attaches on the third paint film 6 of the inner panel surface 3.

In summary, according to a first aspect of the present invention, there is provided a method for painting an automobile body, which comprises: a first paint film-forming step of applying a first paint to an outer plate surface of the automobile body having a basecoat film formed thereon, to form thereon a first paint film having a basecoat hiding ability; a second paint film-forming step of, after the formation of the first paint film, applying a second paint to the first paint film to form thereon a second paint film which has a basecoat hiding ability lower than that of the first paint film and exhibits an apparent paint-film color only by itself or in cooperation with the first paint film; and a third paint film-forming step of, at least after the first paint film-forming step, applying a third paint to an inner panel surface of the automobile body having a basecoat film formed thereon, to form thereon a third paint film exhibiting an apparent paint-film color identical or similar to that of the second paint film of the outer panel surface.

In the present invention, the basecoat hiding ability means an ability to ensure an ultraviolet (300 to 400 nm) transmittance of 0.05% or less and a black/white hiding ability of 10 μm or less under a condition that a paint color has a brightness of 60 or less (wherein an illumination angle is −45 degrees and an acceptance angle is zero degree), and further ensure an ultraviolet (300 to 400 nm) transmittance of 0.05% or less and a black/white hiding ability of 20 μm or less under a condition that a paint color has a brightness of greater than 60 (wherein an illumination angle is −45 degrees and an acceptance angle is zero degree) [see JIS K 5400.7.2(2) f].

Further, the similar colors are defined as colors having a relationship where a color difference therebetween is 2 or less (wherein an illumination angle is −45 degrees and an acceptance angle is zero degree) [see JIS Z 8730].

In the method according to the first aspect and an after-mentioned system according to an eighth aspect of the present invention, at least after the formation of the first paint film, the third paint is applied to the inner panel surface to form thereon the third paint film exhibiting an apparent paint-film color identical or similar to that of the second paint film of the outer panel surface. Thus, the third paint film can hide a dust paint film formed by a dust of the first paint attached on the inner panel surface during the formation of the first paint film. This makes it possible to maintain aesthetic appearance of the inner panel surface in an excellent state.

According to a second aspect of the present invention, in the method according to the first aspect, the second paint film-forming step is performed between the first paint film-forming step and the third paint film-forming step.

In cases where the third paint film-forming step K3 using the third paint film-forming station 17 is performed after completion of both the first paint film-forming step K1 and the second paint film-forming step K2 using the first paint film-forming station 12 and the second paint film-forming station 15 for forming the first paint film 5 and the second film 6 on the outer panel surface 2 of the automobile body 1, as in the method according to the second aspect (the first embodiment), the number of operations of opening/closing an openable/closable member 13, such as the an automobile side door, can be reduced, as compared with the cases where the third paint film-forming step K3 is performed between the first paint film-forming step K1 and the second paint film-forming step K2, as in a method according to an after-mentioned third aspect (the second embodiment), so that a painting operation can be simplified as compared with the method according to the after-mentioned third aspect. In addition, this provides another advantage of being able to suppress the occurrence of an undesirable situation where foreign particles stirred up by an operation of opening/closing the openable/closable member 13 attach on the paint films, to effectively improve paint film quality.

According to a third aspect of the present invention, in the method according to the first aspect, the third paint film-forming step is performed between the first paint film-forming step and the second paint film-forming step.

In the method according to the third aspect, the third paint film is formed after the formation of the first paint film, and then the second paint film is formed. In this case, there is no risk of the occurrence of deterioration in aesthetic appearance due to a phenomenon that a first paint for the first paint film attaches on the third paint film. Further, even if a dust of a third paint sprayed to the inner panel surface of the automobile body during the formation of the third paint film attaches on the first paint film of the outer panel surface to form a dust paint film, the second paint film is formed thereon to allow the dust paint film to be hidden. This makes it possible to prevent the occurrence of an undesirable situation where the third paint is exposed on the outer panel surface to cause deterioration in aesthetic appearance in the outer panel surface of the automobile body, even if respective colors of the first paint film and the third paint film are slightly different from each other.

According to a fourth aspect of the present invention, in the method according to each of the second and third aspects, the color of the first paint film is set to one selected from five achromatic colors having five levels of brightnesses consisting of dark gray, gray, light gray, super-light gray and white, in such a manner as to allow the second paint film to exhibit the apparent paint-film color only by itself, or in cooperation with the first paint film.

In this case, the first paint for the first paint film can have versatility, for example, by setting the first paint film to be covered by the second paint film, to have an achromatic color. This makes it possible to reduce the number of pipes required for the application of the first paint, while effectively preventing deterioration in aesthetic appearance due to a phenomenon that a dust of the first paint applied on the outer panel surface of the automobile body attaches onto the third paint film of the inner panel surface.

According to a fifth aspect of the present invention, in the method according to each of the second and third aspects, the first paint for forming the first paint film 5 incorporates a pigment comprising carbon black 18 and having a basecoat hiding ability, or contains a color pigment 19 in an amount greater than a normal amount for providing a brightness corresponding to that of the second paint film.

In this case, the basecoat-hiding pigment is incorporated in the first paint for forming the first paint film, or an amount of the color pigment to be contained in the first paint is set to a value greater than that the normal value, so that the basecoat hiding ability of the first paint film can be effectively improved. This makes it possible to reflect or absorb light, such as visible light or ultraviolet light, irradiating the outer panel surface by the color pigment and others incorporated in the first paint film, so as to restrain the irradiating light, such as ultraviolet light, from reaching the basecoat film, while simplifying the painting operation by omitting an operation of applying a midcoat paint to the basecoat film formed on the outer panel surface and drying the midcoat paint. This provides an advantage of being able to effectively prevent premature deterioration of the basecoat film in a simple manner.

According to a sixth aspect of the present invention, in the method according to the first aspect, the first paint film to be formed on the outer panel surface in the first paint film-forming step has a brightness less than that of the second paint film.

In this case, the brightness of the first paint film to be formed on the outer panel surface of the automobile body in the first paint film-forming step is set to be less than that of the second paint film to be formed on the outer panel surface of the automobile body in the second paint film-forming step, for example, by setting an amount of a color pigment to be contained in the first paint, at a value greater than the normal value. This provides an advantage of being able to effectively suppress premature deterioration of the basecoat film due to ultraviolet light irradiating the basecoat film, in a simpler manner.

According to a seventh aspect of the present invention, the method according to the first aspect further comprises a clear paint film-forming step of forming a clear paint film at least on the second paint film formed on the outer panel surface.

In the method according to the seventh aspect, a clear paint film is formed on the second paint film formed on the outer panel surface of the automobile body. Thus, the clear paint film can protect the second paint film to effectively maintain weather resistance and smoothness thereof. This makes it possible to sufficiently ensure smoothness of the outer panel surface even if a dust of the third paint sprayed toward the inner panel surface during the formation of the third paint film attaches on the second paint film of the outer panel surface.

According to an eighth aspect of the present invention, there is provided a system for painting an automobile body, which comprises: a first paint film-forming station for applying a first paint to an outer panel surface to an outer plate surface of the automobile body having a basecoat film formed thereon, to form thereon a first paint film having a basecoat hiding ability; a second paint film-forming station for applying a second paint to the first paint film to form thereon a second paint film which has a basecoat hiding ability lower than that of the first paint film and exhibits an apparent paint-film color only by itself or in cooperation with the first paint film; and a third paint film-forming station for, at least after the formation of the first paint film, applying a third paint to an inner panel surface of the automobile body having a basecoat film formed thereon, to form thereon a third paint film exhibiting an apparent paint-film color identical or similar to that of the second paint film of the outer panel surface.

According to a ninth aspect of the present invention, the system according to the eighth aspect further comprises a clear paint film-forming station for forming a clear paint film at least on the second paint film formed on the outer panel surface.

In the system according to the ninth aspect, a clear paint film is formed on the second paint film formed on the outer panel surface of the automobile body. Thus, the clear paint film can protect the second paint film to effectively maintain weather resistance and smoothness thereof. This makes it possible to sufficiently ensure smoothness of the outer panel surface even if a dust of the third paint sprayed toward the inner panel surface during the formation of the third paint film attaches on the second paint film of the outer panel surface.

This application is based on Japanese Patent Application Serial No. 2009-082020, filed in Japan Patent Office on Mar. 30, 2009, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A method for painting an automobile body, comprising:
a first paint film-forming step of applying a first paint to an outer plate surface of the automobile body having a basecoat film formed thereon, to form thereon a first paint film having a basecoat hiding ability;
a second paint film-forming step of, after the formation of the first paint film, applying a second paint to the first paint film to form thereon a second paint film which has a basecoat hiding ability lower than that of the first paint film and exhibits an apparent paint-film color only by itself or in cooperation with the first paint film; and
a third paint film-forming step of, at least after the first paint film-forming step, applying a third paint to an inner panel surface of the automobile body having a basecoat film formed thereon, to form thereon a third paint film exhibiting an apparent paint-film color identical or similar to that of the second paint film of the outer panel surface.

2. The method as defined in claim 1, wherein the second paint film-forming step is performed between the first paint film-forming step and the third paint film-forming step.

3. The method as defined in claim 1, wherein the third paint film-forming step is performed between the first paint film-forming step and the second paint film-forming step.

4. The method as defined in claim 2, wherein the color of the first paint film is set to one selected from five achromatic colors having five levels of brightnesses consisting of dark gray, gray, light gray, super-light gray and white, in such a manner as to allow the second paint film to exhibit the apparent paint-film color only by itself, or in cooperation with the first paint film.

5. The method as defined in claim 2, wherein the first paint for forming the first paint film incorporates a pigment comprising carbon black and having a basecoat hiding ability, or contains a color pigment in an amount greater than a normal amount for providing a brightness corresponding to that of the second paint film.

6. The method as defined in claim 1, wherein the first paint film to be formed on the outer panel surface in the first paint film-forming step has a brightness less than that of the second paint film.

7. The method as defined in claim 1, which further comprises a clear paint film-forming step of forming a clear paint film at least on the second paint film formed on the outer panel surface.

8. A system for painting an automobile body, comprising:
a first paint film-forming station for applying a first paint to an outer panel surface to an outer plate surface of the automobile body having a basecoat film formed thereon, to form thereon a first paint film having a basecoat hiding ability;
a second paint film-forming station for applying a second paint to the first paint film to form thereon a second paint film which has a basecoat hiding ability lower than that of the first paint film and exhibits an apparent paint-film color only by itself or in cooperation with the first paint film; and
a third paint film-forming station for, at least after the formation of the first paint film, applying a third paint to an inner panel surface of the automobile body having a basecoat film formed thereon, to form thereon a third paint film exhibiting an apparent paint-film color identical or similar to that of the second paint film of the outer panel surface.

9. The system as defined in claim 8, which further comprises a clear paint film-forming station for forming a clear paint film at least on the second paint film formed on the outer panel surface.

10. The method as defined in claim 1, wherein:
the basecoat hiding ability is determined by a comparative evaluation, on the basis of a transmittance of ultraviolet of 300 to 400 nm and a black/white hiding ability under a condition that a paint color has a brightness of 60 or less, wherein an illumination angle is −45 degrees and an acceptance angle is zero degree, and transmittance of ultraviolet of 300 to 400 nm and a black/white hiding ability under a condition that a paint color has a brightness of greater than 60, wherein an illumination angle is −45 degrees and an acceptance angle is zero degree; and
said similar colors are defined as colors having a relationship where a color difference therebetween is 2 or less, wherein an illumination angle is −45 degrees and an acceptance angle is zero degree.

11. The system as defined in claim 8, wherein:
the basecoat hiding ability is determined by a comparative evaluation, on the basis of a transmittance of ultraviolet of 300 to 400 nm and a black/white hiding ability under a condition that a paint color has a brightness of 60 or less, wherein an illumination angle is −45 degrees and an acceptance angle is zero degree, and transmittance of ultraviolet of 300 to 400 nm and a black/white hiding ability under a condition that a paint color has a brightness of greater than 60, wherein an illumination angle is −45 degrees and an acceptance angle is zero degree; and
said similar colors are defined as colors having a relationship where a color difference therebetween is 2 or less, wherein an illumination angle is −45 degrees and an acceptance angle is zero degree.

12. The method as defined in claim 3, wherein the color of the first paint film is set to one selected from five achromatic colors having five levels of brightnesses consisting of dark gray, gray, light gray, super-light gray and white, in such a manner as to allow the second paint film to exhibit the apparent paint-film color only by itself, or in cooperation with the first paint film.

13. The method as defined in claim 3, wherein the first paint for forming the first paint film incorporates a pigment comprising carbon black and having a basecoat hiding ability, or contains a color pigment in an amount greater than a normal amount for providing a brightness corresponding to that of the second paint film.
